(19) United States
(12) Patent Application Publication
(10) Pub. No.: US 2026/0089103 A1
(43) Pub. Date: Mar. 26, 2026

(54) TECHNOLOGIES FOR CONGESTION DETECTION IN WIRELESS NETWORKS

(71) Applicant: Apple Inc., Cupertino, CA (US)

(72) Inventors: Ralf Rossbach, Munich (DE); Fangli Xu, Beijing (CN); Bobby Jose, San Diego, CA (US); Vijay Venkataraman, San Jose, CA (US); Srinivas Reddy Mudireddy, San Diego, CA (US); Ping-Heng Kuo, London (GB); Haijing Hu, Los Gatos, CA (US)

(73) Assignee: Apple Inc., Cupertino, CA (US)

(21) Appl. No.: 19/111,764

(22) PCT Filed: Sep. 29, 2022
(86) PCT No.: PCT/CN2022/122865

§ 371 Date: Mar. 13, 2025

(30) Foreign Application Priority Data
Sep. 23, 2022 (WO) PCT/CN2022/121071

(51) Int. Cl. H04L 47/11; H04L 47/20

(52) U.S. Cl. CPC H04L 47/11; H04L 47/20

(57) ABSTRACT

The present application relates to devices and components including apparatus, systems, and methods for detecting congestion in wireless networks.

### TECHNICAL FIELD

This application relates generally to communication networks and, in particular, to technologies for congestion detection in such networks.

### BACKGROUND

Low latency low loss scale throughput (L4S) is a technology based on an Internet Engineering Task Force (IETF) standardization. L4S provides high throughput and low latency for Internet protocol (IP) traffic that may result in improved, fast-radio adaption management and reduce network congestion, queuing, and packet loss.

### BRIEF DESCRIPTION OF THE DRAWINGS

FIG. 1 illustrates a network environment in accordance with some embodiments.

FIG. 2 illustrates devices of the network environment in accordance with some embodiments.

FIG. 3 illustrates layers of a device in accordance with some embodiments.

FIG. 4 is an operation flow/algorithmic structure in accordance with some embodiments.

FIG. 5 is an operation flow/algorithmic structure in accordance with some embodiments.

FIG. 6 illustrates an user equipment in accordance with some embodiments.

FIG. 7 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

Current L4S technology relies on a modified form of an explicit congestion notification (ECN) in which a congestion indication is provided in an IP header to indicate queue buildup in intermediate routers or radio links. Upon reception of a congestion indication, congestion signals may be propagated back to a sender. The signals may be sent via a transmission control protocol (TCP) ECN-echo that triggers scalable congestion control algorithms. A TCP congestion window reduced (CWR) bit may be sent back to acknowledge to the receiver that the congestion-indication echoing was received. Similar signaling may be supported on other layer 4 (L4) protocols such as QUIC.

When congestion is detected, the application server or the application may adjust the application bit rate to meet capacity of the established communication link. As a result, L4S may deliver a seamless user experience even with variable traffic load and radio conditions.

Changing the ECN bits in an IP header as a queue starts to grow to signal congestion may be referred to as marking. ECN/L4S use two least significant bits of a traffic class field in an IP version 4 (IPv4) or IP version 6 (IPv6) header to encode four different codepoints. In traditional ECN implementations, a congestion mark is equivalent to a packet drop. In L4S, the congestion mark serves as an indication instead of dropping the packet.

L4S allows relatively fine granular congestion control depending on the application (for example, with active queue management (AQM) and scalable TCP). L4S allows for improved queue utilization and better use of network resources. If applied to the radio, it may allow for better spectrum utilization. Routers or nodes using AQM may signal congestion indication upon detecting high delay or high buffer status.

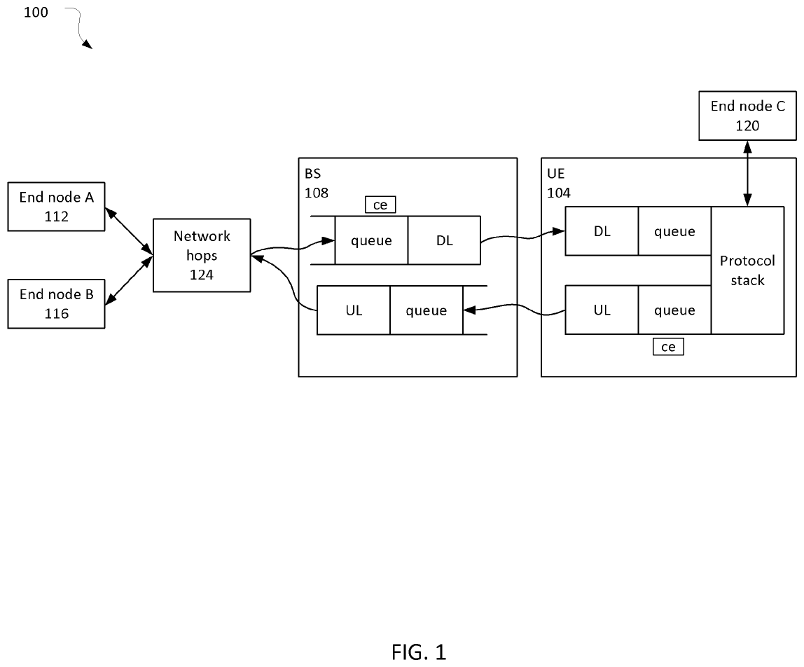

FIG. 1 illustrates a network environment 100 in accordance with some embodiments. The network environment 100 may include a UE 104 coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define LTE, Fifth Generation (5G) NR, or later system standards.

The network environment 100 further includes three end nodes, end node A 112, end node B 116, and end node C 120. While shown separately in FIG. 1, end node C 120 may also be part of UE 104.

The end nodes may communicate with one another through the UE 104, RAN 108, and one or more network hops 124. The end nodes may host application layers that communicate application traffic with one another over the intervening network nodes. The network hops 124 may include hops in a RAN, core network (CN), external data network, etc.

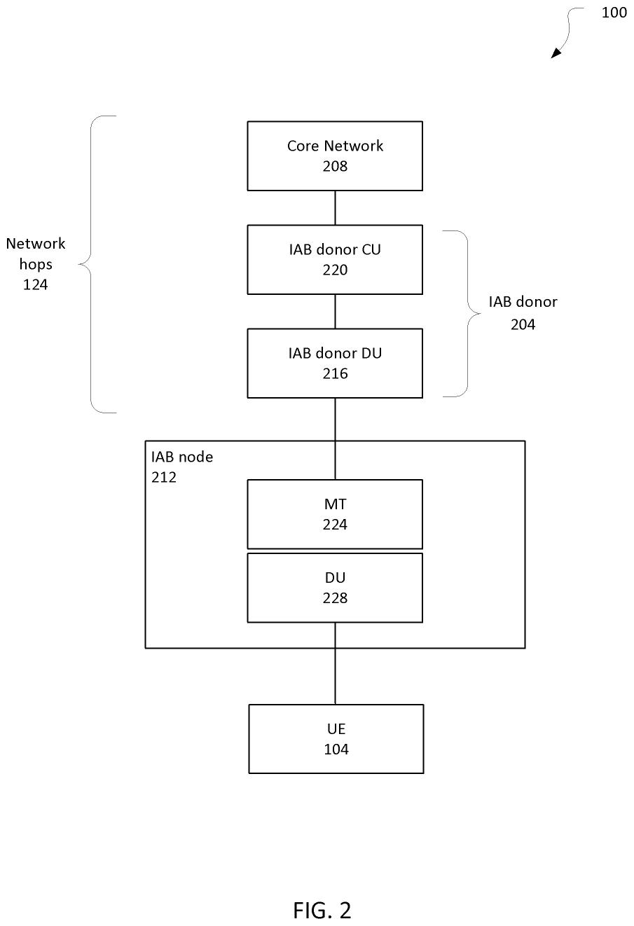

In some embodiments, the BS 108 and devices of the network hops 124 may include integrated access and backhaul (IAB) nodes that facilitate relaying of access traffic by sharing radio resources between access and backhaul links. FIG. 2 illustrates the network environment 100 implementing IAB concepts that may be used in some embodiments. In an IAB deployment, the network hops 124 may include an IAB donor 204 and core network 208. The IAB donor 204 may be a RAN node that provides an interface to the core network 208 and provides wireless backhauling functionality to an IAB node. An IAB node is a RAN node that provides the UE 104 with wireless access and wirelessly backhauls the access traffic to another IAB node or an IAB donor.

The base station 108 may correspond to one or more of the IAB nodes (for example, IAB node 212, IAB donor 204, etc.). In some embodiments, the base station 108 may be separate from the IAB nodes and may be provided, for example, between IAB node 212 and the UE 104. The network hops 124 may include additional IAB nodes between IAB node 212 and the IAB donor 204.

The IAB donor 204 may have a distributed unit (DU) 216 and a centralized unit (CU) 220 disposed on separate devices. In general, the IAB donor CU 220 may handle higher-layer protocols, for example, radio resource control (RRC), packet data convergence (PDCP), and service data adaptation protocol (SDAP) layer protocols, while the IAB donor DU 216 may handle lower-layer protocols, for example, radio link control (RLC), media access control (MAC), and physical (PHY) layer protocols. In some embodiments, the base station 108 may provide CU and DU entities (for example, gNB-CU and gNB-DU).

The IAB node 212 may include a mobile termination (MT) 224 and a DU 228 that is coupled with the UE 104 or another IAB node. The MT 224 may be used to connect the IAB node 212 with an upstream (for example, towards the core network 208) RAN node (for example, IAB donor DU 216). In general, the MT 224 may provide the IAB node 212 with access functionality similar to a UE. For example, the MT 224 may utilize protocols that a typical UE may use to connect to a RAN. The MT 224 may, for example, allow the IAB node 212 to establish signaling radio bearers (SRBs) and/or data radio bearers (DRBs) with a parent node. The MT 224 may perform cell selection to identify an upstream RAN node to join and then set up and utilize an RLC channel through a backhaul adaptation (BAP) layer that provides functionality for routing data for different UE bearers over different routes through the network. The MT 224 may also perform, for example, cell reselection, radio-link failure, etc. In some embodiments, the IAB node to which the MT 224 connects, for example, the IAB donor 204, as shown, or another IAB node, may be considered the base station 108.

In a cellular data path architecture of the network environment 100, queuing may apply to packets in the UE 104, the BS 108, or other RAN nodes. With respect to the UE 104, to ensure layer 2 (L2)/MAC has sufficient data available, new data from upper layers may constantly be added to the local queue. Based on anticipation of uplink grants from the BS 108, the data path may encipher and have new packets ready to be transmitted. However, due to the highly dynamic nature of wireless links in cellular networks such as 5G network at millimeter wave (mmWave) frequencies, it may be possible that throughput may drop for a sustained period of time. This may happen when the UE 104 has a non-line-of-sight (NLOS) connection with the frequency range 2 (FR2) tower. Additionally, due to sub-optimal radio conditions, the wireless link may experience retransmission of packets at several layers such as, for example, a MAC layer or an RLC layer. In such cases, the L2/MAC queues may experience buffer bloat. Similarly, with respect to the BS 108, packets may be queued up and waiting for scheduling opportunity and, based on the bandwidth conditions, the queues may experience buffer bloat. Embodiments of the present disclosure provide for detecting congestion at the queues of the UE 104, the BS 108, or other RAN nodes. Upon detection of a congestion event, embodiments provide for setting a congestion experienced (CE) indication, which may be used to assist an application at one of the end nodes. The CE indication may be provided via ECN/L4S fields in an IP header and elsewhere as described herein.

5G NR and LTE support ECN at the IP layer where a base station and UE may insert ECN codepoints as specified in clause 5 of IETF request for comments (RFC) 3168, “The Addition of Explicit Congestion Notification (ECN) to IP,” September 2001. In particular, a UE and a base station may set a CE codepoint ‘11’ in a PDCP service data unit (SDU) (in the IP packet). However, this means that ECN marking can only happen at the tail of the queue. Given that a UE's L2 buffer can be very large and grant-scheduling delays may exist, an ECN/L4S marking at an end of the queue may come with the disadvantage of additional delay for the ECN codepoint reaching its destination.

In some embodiments, the applications at the end nodes may include applications for extended reality (XR) services that transmit/receive XR traffic over the network. The support of XR services require low latency and high throughput. L4S may be used to reduce latency and congestion and insured desired experience for users of XR services.

ECN/L4S is an end-to-end mechanism that depends on the capability of the transport network. It may enable faster codec rate adaptation at end points and may help to keep latency low and throughput high.

From a radio interface perspective, it may be advantageous to determine whether or not congestion exists at radio layers or other points within an LTE/5G system. In some embodiments, congestion at an air interface may be indicated using one CE bit that is communicated to upper sublayers and translated into respective representation at an IP layer. However, to allow supportive use cases in which full end-to-end ECN/L4S consistency is desired, some embodiments may provide the CE indication with more than one bit (for example, two bits). ECN, L4S, and CE may be used interchangeably throughout this description.

Embodiments describe how the transmitter or receiver may detect a congestion condition at various radio layers of a wireless communication protocol, for example, NR radio layers.

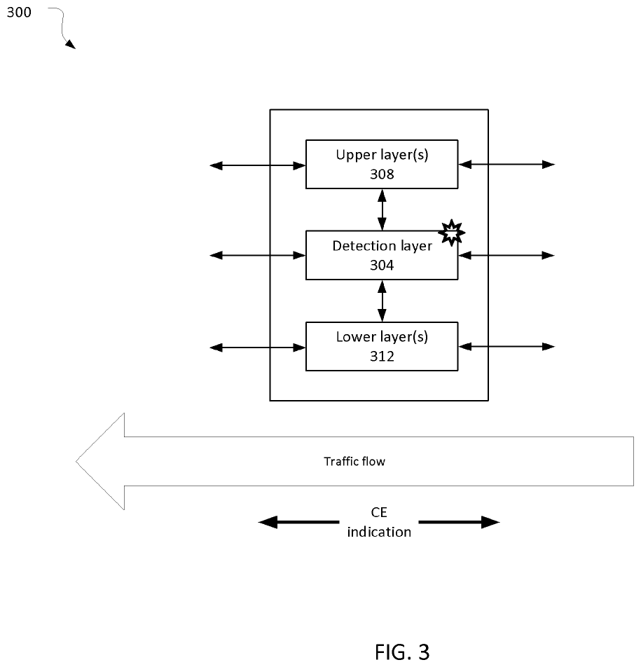

FIG. 3 shows a device 300 in accordance with some embodiments. The device 300 may be the UE 104, base station 108 (as an IAB node or distinct therefrom), or a device of the network hops 124 (for example, an IAB node/donor). The device 300 may include a number of protocol layers, shown generically as detection layer 304, upper layer(s) 308, and lower layer(s) 312. The detection layer 304 may be the layer at which a congestion event is detected. In various embodiment, the detection layer 304 may be an SDAP layer, a PDCP layer, an RLC layer, or a MAC layer. The upper layer(s) 308 and lower layer(s) 312 may be defined with respect to the detection layer 304. The detection may be performed in accordance with any of the embodiments described herein.

In some embodiments, upon detecting the congestion event, the detection layer 304 may inform the upper layer(s) 308. The detection layer 304 may inform the upper layer(s) 308 with a congestion indication or event, for example, in a primitive or a message.

The upper layer(s) 308 may insert a CE indication into packets at the upper layer(s) 308 and transmit the packets to complementary upper layer(s) in other devices.

In some embodiments, upon detecting the congestion event, the detection layer 304 may insert a CE indication into packets at the detection layer 304. This may be used to inform complementary layers in other devices of the congestion.

In some embodiments, upon detecting the congestion event, the detection layer 304 may inform the lower layer(s) 312. The lower layer(s) 312 may insert a CE indication into packets at the lower layer(s) 312 and transmit the packets to complementary lower layer(s) in other devices.

The packets, and included CE indications, may be transmitted from any of the layers of the device 300 in the same direction as the traffic flow in which the congestion was detected, or in the opposite direction.

Some embodiments provide congestion detection at a receiver. The receiver may be in the UE 104, the base station 108, or one of the network hops 124. Receiver-driven CE indications may be described as follows.

A receiver may be in a connection state where packets from the transmitter are actively expected. Assuming bidirectional connections for an interactive type of services, if expected packets are not received, the receiver may take action similar to those resulting from congestion on the receiver path. These actions may include adjusting a codec rate, providing feedback to throttle the data rate at the sender, etc.

A first option of detecting congestion at the receiver may be with respect to a traffic flow with periodical traffic characteristics. The receiver may declare a congestion condition based on (nominal) periodicity of the traffic flow. If the receiver has not received a packet of the traffic flow for more than x times the periodicity, the receiver may declare a congestion condition. It may be noted that this assumes a mode where packets are always expected to be transmitted. For example, when uplink skipping is temporarily disabled during a period of transmission, or when the connection is assumed or detected to be in a state with continuous transmission for a period of time, or when the receiver is able to safely identify a transmission attempt (blind decoding).

In some embodiments, a timer or counter may be specified, defined (or configured by the network) based on multiples of periodicity. This may be useful for XR and other types of traffic. An initial value of a congestion timer may be set in multiples of a configured grant (CG), a semi persistent scheduling (SPS) grant, or traffic flow periodicity. The timer or counter can be in MAC, RLC, PDCP, or in higher layers directly (e.g., in the IP layer).

A second option of detecting congestion at the receiver may correspond to a situation in which, once a packet was transmitted, another packet is expected in the receive direction within a specified or configured amount of time. The expected packet may be sent in response to the transmitted packet or represent any packet sent in the receive direction. This option may use UE or RAN awareness of inherent traffic characteristics for a flow. For example, knowledge of the expected traffic pattern may be used to anticipate expected packets accordingly.

If the receiver (in the UE 104 or BS 108) does not receive packets with respect to an SPS/CG configuration, logical channel (LCH), quality of service (QoS) flow or data radio bearer (DRB) for a specified or configured time, the receiver may declare a congestion condition for the whole traffic flow. A layer of the receiver may provide a CE indication, based on the declared congestion condition, to a complementary layer in another device or provide the CE indication to upper layers.

If the receiver does not receive packets on an SPS/CG config, LCH, QoS flow or DRB for a predetermined amount of time (which may be based on device implementation), the receiver declares a congestion condition for the whole traffic flow and provides a CE indication to a complementary layer in another device or to upper layers.

A suboption of the second option, e.g., option 2a, may be L3/L4 related parameter driven or based on typical traffic characteristics. For example, the receiver may monitor an actual receive (Rx) data rate as a function of round-trip time (RTT) (in relation to the Tx data rate). The actual Rx data rate may then be compared with an expected Rx data rate of the traffic flow. If there is a deviation from what is expected that is greater than a predetermined threshold, then the receiver may declare a congestion condition.

For options 2 and 2a, access stratum layers may receive input on inherent traffic characteristics from higher layers, for example, non-access stratum NAS layers or an application layer. The input may be used to define the conditions or key performance indicators (KPIs) that are to be associated with congestion condition.

In response to the detected congestion condition through one of the options above, the detecting layer may inform upper layers. The upper layers may then react according to one or more of the following options.

In a first option, an upper layer may set the CE bit for the flow in the IP layer in the receive direction. Thus, the CE bit may provide the indication in the same direction as the traffic flow in which the condition was detected. When a target end node receives the CE indication set in the IP layer, its transport layer may respond according to existing actions supported in the respective transport layer protocol (for example, TCP may respond with ECN-Echo in the transmit direction, for example, toward the source end node).

In a second option, an upper layer may trigger a congestion indication to lower layers directly, to signal congestion faster when required. The lower layers may provide the CE indication in a packet that is sent in the same direction as the traffic flow or in an opposite direction.

Some embodiments provide congestion detection at a transmitter. The transmitter may be in the UE 104, the base station 108, or one of the network hops 124. Transmitter-driven CE indications may be described as follows.

In a first option, congestion may be detected based on buffer status. This may be done in SDAP, PDCP, RLC, MAC based on, for example, QoS flows, DRBs, RLC channels, or LCHs. This may be done separately for each layer.

In some embodiments, the network may configure queue utilization as a threshold. The threshold may be, for example, a maximum percentage, or maximum number of bytes in an L2 buffer. One threshold may be provided for a CE-set indication, which may be used to indicate presence of congestion, and another threshold may be provided for a CE-clear indication, which may be used to indicate absence of congestion. While many embodiments describe congestion as existing in a binary state, for example, either congestion is present or is not, other embodiments may provide for different levels of congestion being detected/signaled in similar matters.

In a second option, congestion may be detected based on a delay budget or packet validity time. This may be done in accordance with one or more of the following suboptions.

In a first suboption of the second option, e.g., option 2A, the transmitter may declare a congestion condition if lower layers have not confirmed successfully transmission of a PDU after a specified or configured fraction of a packet delay budget (PDB). A PDB may define an upper bound for a time that a packet may be delayed between a UE and an N6 termination point at a user plane function (UPF) of the core network.

In a second suboption of the second option, e.g., option 2B, the transmitter may declare a congestion condition if lower layers have not confirmed successfully transmission of a group of PDUs (for example, a PDU set) after a specified or configured fraction of a PDU Set Delay Budget (PSDB).

In a third suboption of the second option, e.g., option 2C, the PDCP transmitter may declare a congestion condition if lower layers have not confirmed successfully transmission of a PDU after a specified or configured fraction of a PDCP discard timer, which may be configured for each DRB. A PDCP transmitter may start the PDCP discard timer upon reception of a PDCP SDU from an upper layer. The PDCP transmitter may discard the PDCP SDU upon expiration of the timer or successful delivery of the PDCP SDU is confirmed in a PDCP status report. In some embodiments, the PDCP transmitter may obtain a transmit-confirm indication from lower layers after a packet is successfully transmitted. For example, when the PDCP layer submits a packet to a lower layer, the MAC may confirm a successful transmission upon receiving a HARQ-ACK. A similar process may be done at the RLC layer.

In a fourth suboption of the second option, e.g., option 2D, the PDCP transmitter may declare a congestion condition if lower layers have not confirmed successfully transmission of a group of PDUs after a specified or configured fraction of a discard timer associated with a PDU Set.

In a fifth suboption of the second option, e.g., option 2E, the PDCP transmitter may declare a congestion condition upon expiration of the PDCP discard timer. In some embodiments, if the PDCP discard timer expires for one SDU, the congestion condition may be declared. In other embodiments, the congestion condition may be declared if the PDCP discard timer expires for a predetermined threshold number of SDUs over a period of time. The predetermined threshold number or period of time may be configured by the network.

It may be noted that one or more of options 2A-2D may be realized by introducing a new timer or counter. The value of the timer/counter can be configured by the network according to characteristics of the traffic flow/DRB.

In a third option, congestion may be detected based on RTT. For example, a sender may utilize round trip time measurements (based on time between sending a probe and receiving a response, for example) or quality of experience (QoE) measurements to monitor the quality of the link. The quality of the link may be determined on an end-to-end basis or via dedicated measurements. The sender may declare a congestion condition upon detection of high RTT (e.g., above a predetermined threshold).

In a fourth option, congestion may be detected based on a maximum number of experienced retransmissions or a maximum number of experienced missing acknowledgments (ACKs) for a period of time. The maximum number or period of time may be configured by a network.

In the downlink direction, if the UE 104 does not receive a number of positive acknowledgements for its PDUs sent in the uplink direction, the UE 104 may declare a congestion condition for the whole flow and indicate the same to upper layers. The number of positive acknowledgements may be defined for a traffic flow.

In the uplink direction, if the base station 108 does not receive a number of positive acknowledgements for its PDUs sent in the downlink direction, the base station may declare a congestion condition for the whole flow and indicates the same to upper layers. The number of positive acknowledgements may be defined for a traffic flow.

The number of missing ACKs (or maximum number of experienced retransmissions) can be set based on, for example, a typical RTT. This number must be shorter than the timeout for the connection. For example, the number may be set to be shorter than a maximum number of retransmissions on a particular layer. The definition can be based on RLC or MAC.

Some embodiments provide congestion detection based on specific thresholds. These embodiments may be provided in conjunction with one or more embodiments described herein (for example, receiver-driven detection or transmitter-driven detection). Detecting congestion and marking CE based on specific thresholds may be performed by one or more of the following options.

In a first option, congestion may be declared when a number of RLC retransmissions becomes greater than a threshold. The threshold may be referred to as an RLC retransmission threshold (RLCReTxThreshold). The threshold can be configured by the network via RRC, for example.

In a second option, a device may detect a congestion event if there is a sequence number (SN) gap in RLC (or PDCP). For example, if a predetermined number of SNs are missing, the device may determine the traffic flow is experiencing congestion.

In a third option, a congestion condition may be detected when a sojourn timer e.g., average time spent in the queue for a flow is greater than a predetermined threshold, which may be specified or preconfigured. The queue may be in any layer, for example, the detection layer or in a different layer. Additionally/alternatively, the congestion condition may be detected when an actual buffer residency time a packet has spent in an RLC or PDCP buffer exceeds a predetermined threshold, which may be specified or preconfigured.

In a fourth option, the receiver may detect congestion based on a hybrid automatic repeat request (HARQ) retransmission greater than a specific or configured threshold. In some embodiments, the threshold may be configured by RRC signaling.

A fifth option may operate in accordance with options 2 (or 2a) of receiver-based congestion detecting described above. In the fifth option, congestion may be declared based on a time window, counter, or watchdog timer that “fires” an alarm when a configured number of missing packets is reached. The configuration can be driven out of the conditions that define those options.

Some embodiments provide congestion detection based on predictions. For example, congestion may be detected and CE may be marked based on a congestion prediction, which may be valid for uplink and downlink. This may be done in accordance with one or more the following options.

In a first option, radio quality metrics may be used to predict or detect congestion. This may be based on a supervision of radio-related parameters such as reference signal receive power (RSRP), reference signal receive quality (RSRQ), signal to interference plus noise ratio (SINR), block error rate (BLER), etc. In addition, options 1-4 in threshold-based congestion detection discussed above may provide input to refine the metrics.

In a second option, if prediction methods are used to anticipate the quality of the link in the future, CE may be marked before the congestion reaches a level associated with a congestion event (for example, before the traffic flow is experiencing congestion).

In a first suboption of the second option, e.g., option 2a, a sender or receiver may set CE to indicate the “likelihood” that a congestion will be experienced if corrective action is not pursued. This may be especially useful when a prediction-based method is used.

In a third option, a sender or receiver may predict congestion and set CE based on location and time. For instance, if the device is in a busy downtown, and the device or the network has access to overload statistics (e.g., on a cell or based on an accessible database), the device may predict congestion with a relatively high level of accuracy.

In some embodiments, a packet having a CE indication may be prioritized over other packets. For example, in order to provide the CE indication as fast as possible, the packets that include the CE indication may be considered as “high” priority packets and prioritized in queues over any other traffic, e.g., TCP ACKs or best effort traffic.

Upon detection of the congestion condition, the congestion detection layer (SDAP, PDCP, RLC, or MAC) may inform the target layer handling the signaling of the CE indication to trigger transmission over the network.

The CE indication may be in a new 1-bit field in either SDAP, PDCP, RLC, or MAC layers. Additionally/alternatively, lower layers could utilize two bits. In some embodiments, the two bits may correspond to codepoints according to ECN codepoints shown in Table 1 or L4S codepoints shown in Table 2 below.

TABLE 1

| Binary codepoint | Codepoint name | Meaning |
|---|---|---|
| 00 | Not-ECT | Not ECN-capable transport |
| 01 | ECT(1) | ECN-capable transport |
| 10 | ECT(0) | ECN-capable transport |
| 11 | CE | Congestion experienced |

TABLE 2

| Binary codepoint | Codepoint name | Meaning |
|---|---|---|
| 00 | Not-ECT | Not ECN-capable transport |
| 01 | ECT(1) | L4S-capable transport |
| 10 | ECT(0) | Not L4S capable transport |
| 11 | CE | Congestion experienced |

These codepoints may be similar to those described in IETF RFC 3168.

The transmitter may only need to provide the CE indication when packets are queued up after/within PDCP processing or in an L2 layer. Otherwise, the transmitter can mark ECN/L4S bits in a PDCP SDU or the IP packet directly (e.g., at the end of the PDCP queue according to existing specifications).

In some embodiments, a rule may defined as to which CE indication (the one in lower layers or the one in the IP layer) supersedes the other. The default case may be that the most recent CE indication (coming either from the RAN or from the IP layer) may overwrite/update any earlier CE setting for the traffic flow

The rule may also be applied to the case in which lower layers detect congestion early and report CE in the forward direction. In parallel to CE reporting in the forward direction, lower layers may inform the application layer to apply CE for the traffic flow directly. In other words, lower layers may signal CE for only a period of time, for example, depending on the size of the PDCP queue or until the application layer sets or detects CE on its own. Implementation can handle the synchronization of updates.

Other rules may also be defined. For example, a rule may be defined in which application layer indications can only be overwritten by lower layers only if CE bits are currently !=‘11’ and a CE set event is newly detected, while a CE clear event may have to be approved by the application layer/IP. The exact behavior may differ for different applications, subject to network configuration or implementation.

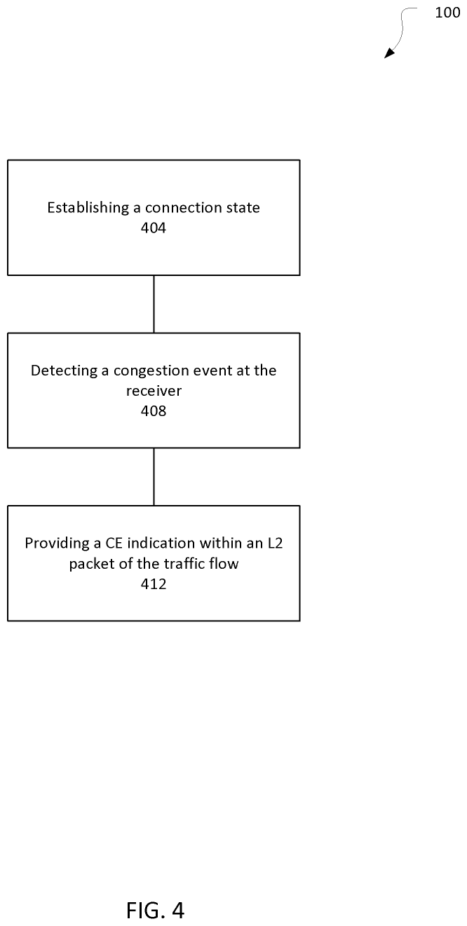

FIG. 4 is an operation flow/algorithmic structure 400 in accordance with some embodiments. The operation flow/algorithmic structure 400 may be implemented by a receiver included in a UE (for example, UE 104 or UE 600), or a network node (for example, BS 108, IAB node 212, IAB donor 204, or network node 700) or components therein, for example, processing circuitry 604 or 704.

The operation flow/algorithmic structure 400 may include, at 404, establishing a connection state. The connection state may be established with a transmitter via a wireless interface. The connection state with the transmitter may be established to communicate data of a traffic flow from a source end node to a target end node. In some embodiments, the data of the traffic flow may include XR data to support XR services. In some embodiments, the connection state may be one in which the transmitter is actively expected to transmit packets to the receiver.

The operation flow/algorithmic structure 400 may further include, at 408, detecting a congestion event at the receiver.

In some embodiments, the receiver may detect the congestion event by determining a packet of the traffic flow is not received within an expected period of time. The expected period of time may be based on a periodicity associated with the traffic flow. The periodicity may be defined or otherwise determined by a periodic traffic characteristic of the traffic flow. In some instances, the expected period of time used to detect the congestion event may be an integer multiple of the periodicity. This may be tracked by setting a timer or a counter with a value that corresponds to the integer multiple of the periodicity.

In some embodiments, the expected period of time used to detect the congestion event may be based on transmission of a packet. For example, a device having the receiver may expect to receive a second packet a certain period of time after transmitting a first packet. The first packet may be transmitted to the device having the transmitter or to another device.

In some embodiments, the receiver may detect the congestion event based on traffic characteristics observed by the receiver. For example, the receiver may determine an expected data rate associated with traffic flow and compare the expected data rate to an actual data rate observed by the receiver. If the actual data rate differs from the expected data rate by a predetermined threshold, the receiver may determine that a congestion event has occurred.

In embodiments in which detection of the congestion event is based on characteristics of the traffic flow, the access stratum layers of the receiver may receive input on those characteristics from higher layers or an application layer.

In some embodiments, the receiver may detect the congestion event based on a number of HARQ retransmissions. For example, if the number of retransmissions is greater than a predetermined threshold, the receiver may determine that congestion is being experienced.

While some embodiments describe the congestion event as being associated with detected congestion, other embodiments may detect a congestion event associated with a detected absence of congestion. Similarly, the congestion event may correspond to a change in congestion levels.

The operation flow/algorithmic structure 400 may further include, at 412, providing a CE indication within an L2 packet of the traffic flow. The CE indication may be one bit or two bits. A one bit CE indication may indicate whether congestion is present (for example, provide a CE-set indication) or whether congestion is absent (for example, provide a CE-clear indication). A two bit CE indication may be used to provide the presence/absence of congestion and CE capability information similar to that described above with respect to Tables 1 or 2. In some embodiments, two or more bits of CE indication may be used to provide an indication of specific congestion levels that are being experienced by the traffic flow.

In some embodiments, the L2 packet in which the CE indication is placed may correspond to the layer at which the congestion was detected. In other embodiments, the layer that initially detects the congestion may be different from the layer that provides the CE indication in the L2 packet.

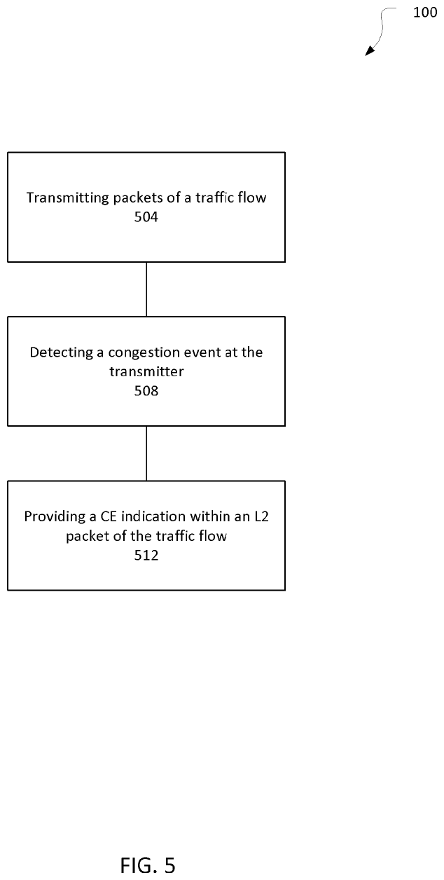

FIG. 5 is an operation flow/algorithmic structure 500 in accordance with some embodiments. The operation flow/algorithmic structure 500 may be implemented by a transmitter included in a UE (for example, UE 104 or UE 600), or a network node (for example, BS 108, IAB node 212, IAB donor 204, or network node 700) or components therein, for example, processing circuitry 604 or 704.

The operation flow/algorithmic structure 500 may include, at 504, transmitting packets of a traffic flow. The connection state may be established with a receiver via a wireless interface. The connection state with the receiver may be established to communicate data of a traffic flow from a source end node to a target end node. In some embodiments, the data of the traffic flow may include XR data to support XR services.

The operation flow/algorithmic structure 500 may further include, at 508, detecting a congestion event at the transmitter.

In some embodiments, the transmitter may detect the congestion event based on a buffer status. For example, if the buffer is utilized more than a first predetermined threshold, the transmitter may determine that congestion is present. Utilization may be based on percentage of the buffer that is being used or an amount of data in the buffer. Conversely, if the buffer is utilized less than a second predetermined threshold, the transmitter may determine that congestion is not present.

In some embodiments, the transmitter may detect the congestion event based on a delay budget. For example, the transmitter may detect the congestion event if it determines that a transmission of a PDU or group of PDUs is not confirmed as successfully transmitted within a predetermined fraction of a packet delay budget, PDU set delay budget, or discard timer.

In some embodiments, the transmitter may detect the congestion event based on an RTT. For example, the transmitter may compare an RTT associated with traffic flow to a predetermined threshold. A congestion event may be detected based on this comparison. For example, if the RTT is greater than the predetermined threshold, the transmitter may determine that congestion is present. If the RTT is less than the predetermined threshold, the transmitter may determine that congestion is not present.

In some embodiments, the transmitter may detect the congestion event based on a number of experienced retransmissions or missing acknowledgments. The retransmissions may be RLC or HARQ retransmissions.

The operation flow/algorithmic structure 500 may further include, at 512, providing a CE indication within an L2 packet of the traffic flow. The CE indication may be one bit or two bits. A one bit CE indication may indicate whether congestion is present (for example, provide a CE-set indication) or whether congestion is absent (for example, provide a CE-clear indication). A two bit CE indication may be used to provide the presence/absence of congestion and CE capability information such as that described above with respect to Tables 1 or 2. In some embodiments, two or more bits of CE indication may be used to provide an indication of specific congestion levels that are being experienced by the traffic flow.

In some embodiments, the L2 packet in which the CE indication is placed may correspond to the layer at which the congestion was detected. In other embodiments, the layer that initially detects the congestion may be different from the layer that provides the CE indication in the L2 packet.

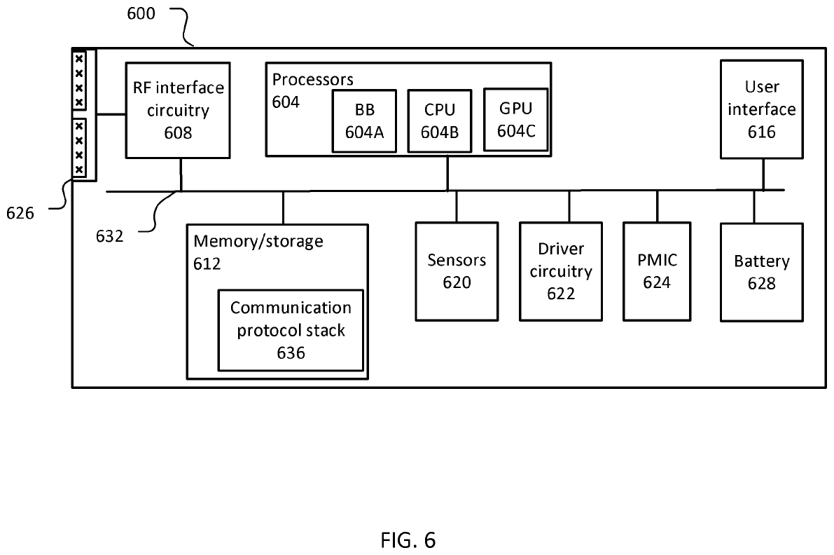

FIG. 6 illustrates a UE 600 in accordance with some embodiments. The UE 600 may be similar to and substantially interchangeable with UE 104 of FIG. 1.

The UE 600 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 600 may include processors 604, RF interface circuitry 608, memory/storage 612, user interface 616, sensors 620, driver circuitry 622, power management integrated circuit (PMIC) 624, antenna structure 626, and battery 628. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 632, which may represent any type of interface, input/output, bus (local, system, or expansion), transmission line, trace, or optical connection that allows various circuit components (on common or different chips or chipsets) to interact with one another.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage 612 to cause the UE 600 to perform operations as described herein.

In some embodiments, the baseband processor circuitry 604A may access a communication protocol stack 636 in the memory/storage 612 to communicate over a 3GPP compatible network. In general, the baseband processor circuitry 604A may access the communication protocol stack 636 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 608.

The baseband processor circuitry 604A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 612 may include one or more non-transitory, computer-readable media that includes instructions (for example, communication protocol stack 636) that may be executed by one or more of the processors 604 to cause the UE 600 to perform various operations described herein. The memory/storage 612 include any type of volatile or non-volatile memory that may be distributed throughout the UE 600. In some embodiments, some of the memory/storage 612 may be located on the processors 604 themselves (for example, L1 and L2 cache), while other memory/storage 612 is external to the processors 604 but accessible thereto via a memory interface. The memory/storage 612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 608 may include transceiver circuitry and radio frequency front module (RFEM) that allows the UE 600 to communicate with other devices over a radio access network. The RF interface circuitry 608 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 626 and proceed to filter and amplify (with a low-noise amplifier) the signal. The signal may be provided to a receiver of the transceiver that down-converts the RF signal into a baseband signal that is provided to the baseband processor of the processors 604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 626.

In various embodiments, the RF interface circuitry 608 may be configured to transmit/receive signals in a manner compatible with NR access technologies.

The antenna 626 may include antenna elements to convert electrical signals into radio waves to travel through the air and to convert received radio waves into electrical signals. The antenna elements may be arranged into one or more antenna panels. The antenna 626 may have antenna panels that are omnidirectional, directional, or a combination thereof to enable beamforming and multiple input, multiple output communications. The antenna 626 may include microstrip antennas, printed antennas fabricated on the surface of one or more printed circuit boards, patch antennas, or phased array antennas. The antenna 626 may have one or more panels designed for specific frequency bands including bands in FR1 or FR2.

The user interface circuitry 616 includes various input/output (I/O) devices designed to enable user interaction with the UE 600. The user interface 616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 600.

The sensors 620 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 622 may include software and hardware elements that operate to control particular devices that are embedded in the UE 600, attached to the UE 600, or otherwise communicatively coupled with the UE 600. The driver circuitry 622 may include individual drivers allowing other components to interact with or control various I/O devices that may be present within, or connected to, the UE 600. For example, the driver circuitry 612 may include circuitry to facilitate coupling of a UICC (for example, UICC 68) to the UE 600. For additional examples, driver circuitry 622 may include a display driver to control and allow access to a display device, a touchscreen driver to control and allow access to a touchscreen interface, sensor drivers to obtain sensor readings of sensor circuitry 620 and control and allow access to sensor circuitry 620, drivers to obtain actuator positions of electro-mechanic components or control and allow access to the electro-mechanic components, a camera driver to control and allow access to an embedded image capture device, audio drivers to control and allow access to one or more audio devices.

The PMIC 624 may manage power provided to various components of the UE 600. In particular, with respect to the processors 604, the PMIC 624 may control power-source selection, voltage scaling, battery charging, or DC-to-DC conversion.

In some embodiments, the PMIC 624 may control, or otherwise be part of, various power saving mechanisms of the UE 600 including DRX as discussed herein.

A battery 628 may power the UE 600, although in some examples the UE 600 may be mounted deployed in a fixed location, and may have a power supply coupled to an electrical grid. The battery 628 may be a lithium ion battery, a metal-air battery, such as a zinc-air battery, an aluminum-air battery, a lithium-air battery, and the like. In some implementations, such as in vehicle-based applications, the battery 628 may be a typical lead-acid automotive battery.

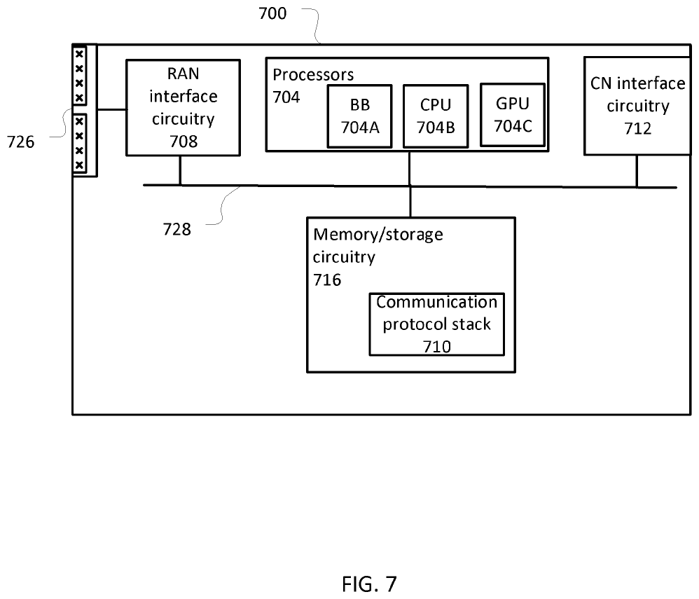

FIG. 7 illustrates a network node 700 in accordance with some embodiments. The network node 700 may be similar to and substantially interchangeable with base station 108, a device implementing one of the network hops 124, a network-controlled repeater, or a server in a core network or external data network.

The network node 700 may include processors 704, RF interface circuitry 708 (if implemented as an access node), core network (CN) interface circuitry 712, memory/storage circuitry 716, and antenna structure 726.

The components of the network node 700 may be coupled with various other components over one or more interconnects 728.

The processors 704, RF interface circuitry 708, memory/storage circuitry 716 (including communication protocol stack 710), antenna structure 726, and interconnects 728 may be similar to like-named elements shown and described with respect to FIG. 6.

The CN interface circuitry 712 may provide connectivity to a core network, for example, a 5th Generation Core network (5GC) using a 5GC-compatible network interface protocol such as carrier Ethernet protocols, or some other suitable protocol. Network connectivity may be provided to/from the network node 700 via a fiber optic or wireless backhaul. The CN interface circuitry 712 may include one or more dedicated processors or FPGAs to communicate using one or more of the aforementioned protocols. In some implementations, the CN interface circuitry 712 may include multiple controllers to provide connectivity to other networks using the same or different protocols.

In some embodiments, the network node 700 may be coupled with transmit receive points (TRPs) using the antenna structure 726, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.
Example 1 includes a method of operating a first device, the method comprising: establishing a connection state in which packets of a traffic flow are expected to be received from a second device over a wireless interface; detecting a congestion event based the traffic flow; providing a congestion experienced (CE) indication within a layer 2 (L2) packet of the traffic flow based on detecting the congestion event. The devices may be a UE, base station, network hop device (e.g., an IAB-DU, an IAB-MT, a network-controlled repeater, an IAB-CU, a gNB-DU, a gNB-CU), server, etc.
Example 2 includes a method of example 1 or some other example herein, wherein detecting the congestion event comprises: determining that a packet of the traffic flow is not received within an expected period of time.
Example 3 includes the method of example 2 or some other example herein, wherein the traffic flow is associated with a periodic traffic characteristic and the method further comprises: determining a periodicity associated with the traffic flow based on the periodic traffic characteristic; and determining the expected period of time based on the periodicity.
Example 4 includes a method of example 3 or some other example herein, wherein the expected period of time is an integer multiple of the periodicity.
Example 5 includes a method of example 3 or some other example herein, further comprising: setting a timer or counter based on the periodicity; and detecting the congestion event based on a value of the timer or counter.
Example 6 includes the method of example 3 or some other example herein, wherein the periodic traffic characteristic is defined based on a configured grant or semi-persistent scheduling of the traffic flow.
Example 7 includes the method of example 2 or some other example herein, further comprising: transmitting a packet to the second device, wherein the expected period of time is based on transmitting the packet to the second device.
Example 8 includes the method of example 7 or some other example herein, wherein the expected period of time is predefined, configured by a base station, or based on a user equipment implementation.
Example 9 includes the method of example 1 or some other example herein, further comprising: determining an expected data rate associated with the traffic flow; determining an actual data rate is less than the expected data rate by a first threshold; and detecting the congestion event based on determining the actual data rate is less than the expected data rate by the first threshold.
Example 10 includes the method of example 1 or some other example herein, further comprising: receiving, at an access stratum layer, an indication of a traffic characteristic associated with the traffic flow; and detecting the congestion event based on the traffic characteristic.
Example 11 includes a method of example 1 or some other example herein, further comprising: detecting the congestion event at a first layer of the first device; informing a second layer of the congestion event; and providing the CE indication with the second layer.
Example 12 includes a method of example 1 or some other example herein, further comprising: transmitting a congestion indication to the transmitter based on detecting the congestion event, wherein the congestion indication is sent with a priority greater than other traffic to be sent to the transmitter.
Example 13 includes a method of operating a first device, the method comprising: transmitting packets of a traffic flow to a second device over a wireless interface; detecting a congestion event based the traffic flow; setting a congestion experienced (CE) bit within an L2 packet of the traffic flow based on detecting the congestion event.
Example 14 includes the method of example 13 or some other example herein, further comprising: detecting the congestion event based on a delay budget associated with the traffic flow.
Example 15 includes the method of example 14 or some other example herein, further comprising: detecting the congestion event based on a determination that a transmission of a protocol data unit (PDU) or group of PDUs is not confirmed as successfully transmitted within a predetermined fraction of a packet delay budget, a PDU set delay budget, or a discard timer.
Example 16 includes a method of example 13 or some other example herein, further comprising: determining a round trip time (RTT) associated with the traffic flow is above a predetermined threshold; and detecting the congestion event based on determining the RTT is above the predetermined threshold.
Example 17 includes the method of example 13 or some other example herein 13, further comprising: detecting the congestion event based on a number of missing acknowledgments associated with the traffic flow being greater than a predetermined threshold.
Example 18 includes the method of example 13 or some other example herein, further comprising: detecting the congestion event based on a number of radio link control (RLC) or hybrid automatic repeat request (HARQ) retransmissions being greater than a predetermined threshold.
Example 19 includes the method of example 13 or some other example herein, further comprising: detecting, in a radio link control (RLC) layer or packet data convergence protocol (PDCP) layer, a gap in sequence numbers larger than a predetermined threshold; and detecting the congestion event based on detecting the gap.
Example 20 includes a method of example 13 or some other example herein, further comprising: detecting a buffer residency time associated with one or more packets of the traffic flow is greater than a predetermined threshold; and detecting the congestion event based on detecting the buffer residency time is greater than the predetermined threshold.
Example 21 includes a method of example 13 or some other example herein, further comprising: determining a radio quality metric is below a predetermined threshold; and detecting the congestion event based on determining the radio quality metric is below the predetermined threshold.
Example 22 includes the method of example 13 or some other example herein, further comprising: predicting a quality of a link for the traffic flow will be below a predetermined threshold; and detecting the congestion event based on predicting the quality of the link will be below the predetermined threshold.
Example 23 includes the method of example 13 or some other example herein, further comprising: determining the first device is in a predetermined location at a predetermined period of time; and detecting the congestion event based on determining the first device is in the predetermined location at the predetermined period of time.

Another example may include one or more non-transitory computer-readable media comprising instructions to cause an electronic device, upon execution of the instructions by one or more processors of the electronic device, to perform one or more elements of a method described in or related to any of examples 1-23, or any other method or process described herein.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example include a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-23. (canceled)

24. One or more non-transitory, computer-readable media having instructions that, when executed, cause processor circuitry to:
establish a connection state in which packets of a traffic flow are expected to be received from a device over a wireless interface;
detect a congestion event based the traffic flow; and
provide a congestion experienced (CE) indication within a layer 2 (L2) packet of the traffic flow based on detection of the congestion event.

25. The one or more non-transitory, computer-readable media of claim 24, wherein to detect the congestion event the processor circuitry is to:
determine that a packet of the traffic flow is not received within an expected period of time.

26. The one or more non-transitory, computer-readable media of claim 25, wherein the traffic flow is associated with a periodic traffic characteristic and the instructions, when executed, further cause the processor circuitry to:
determine a periodicity associated with the traffic flow based on the periodic traffic characteristic; and
determine the expected period of time based on the periodicity.

27. The one or more non-transitory, computer-readable media of claim 26, wherein the expected period of time is an integer multiple of the periodicity.

28. The one or more non-transitory, computer-readable media of claim 26, wherein the instructions, when executed, further cause the processor circuitry to:
set a timer or counter based on the periodicity; and
detect the congestion event based on a value of the timer or counter.

29. The one or more non-transitory, computer-readable media of claim 26, wherein the periodic traffic characteristic is defined based on a configured grant or semi-persistent scheduling of the traffic flow.

30. The one or more non-transitory, computer-readable media of claim 25, wherein the L2 packet is a first packet and the instructions, when executed, further cause the processor circuitry to:
cause transmission of a second packet to the device,
wherein the expected period of time is based on transmission of the second packet to the device.

31. The one or more non-transitory, computer-readable media of claim 24, wherein the instructions, when executed, further cause the processor circuitry to:
determine an expected data rate associated with the traffic flow;
determine an actual data rate is less than the expected data rate by a first threshold; and
detect the congestion event based on determination the actual data rate is less than the expected data rate by the first threshold.

32. The one or more non-transitory, computer-readable media of claim 24, wherein the instructions, when executed, further cause the processor circuitry to:
receive, at an access stratum layer, an indication of a traffic characteristic associated with the traffic flow; and
detect the congestion event based on the traffic characteristic.

33. The one or more non-transitory, computer-readable media of claim 24, wherein the instructions, when executed, further cause the processor circuitry to:
detect the congestion event at a first layer;
inform a second layer of the congestion event; and
provide the CE indication with the second layer.

34. The one or more non-transitory, computer-readable media of claim 24, wherein the instructions, when executed, further cause the processor circuitry to:
transmit the L2 packet from a first queue with a priority greater than other L2 packets in the first queue.

35. A method comprising:
causing transmission of packets of a traffic flow to a device over a wireless interface;
detecting a congestion event based the traffic flow; and
setting one or more congestion experienced (CE) bits within a layer 2 (L2) packet of the traffic flow based on detecting the congestion event.

36. The method of claim 35, further comprising:
detecting the congestion event based on a delay budget associated with the traffic flow.

37. The method of claim 36, further comprising:
detecting the congestion event based on a determination that a transmission of a protocol data unit (PDU) or group of PDUs is not confirmed as successfully transmitted within a predetermined fraction of a packet delay budget, a PDU set delay budget, or a discard timer.

38. The method of claim 35, further comprising:
comparing a round trip time (RTT) associated with the traffic flow to a predetermined threshold; and
detecting the congestion event based on comparing the RTT to the predetermined threshold.

39. The method of claim 35, further comprising:
detecting the congestion event based on a number of missing acknowledgments associated with the traffic flow being greater than a predetermined threshold.

40. The method of claim 35, further comprising:
detecting the congestion event based on a number of radio link control (RLC) or hybrid automatic repeat request (HARQ) retransmissions being greater than a predetermined threshold.

41. The method of claim 35, further comprising:
detecting a buffer residency time associated with one or more packets of the traffic flow is greater than a predetermined threshold; and
detecting the congestion event based on detecting the buffer residency time is greater than the predetermined threshold.

42. The method of claim 35, further comprising:
determining a radio quality metric is below a predetermined threshold; and
detecting the congestion event based on determining the radio quality metric is below the predetermined threshold.

43. The method of claim 35, further comprising:
predicting a quality of a link for the traffic flow will be below a predetermined threshold; and
detecting the congestion event based on predicting the quality of the link will be below the predetermined threshold.
